(19) United States
(12) Patent Application Publication
(10) Pub. No.: US 2005/0225637 A1
(43) Pub. Date: Oct. 13, 2005

(54) Area monitoring

(75) Inventor: Stefan Eghbalian, London (GB)

Correspondence Address: STEUBING AND MCGUINESS & MANARAS LLP, 125 NAGOG PARK, ACTON, MA, 01720, US

(73) Assignee: Globaleye Network Intelligence Ltd.

(21) Appl. No.: 11/092,404

(22) Filed: Mar. 29, 2005

(30) Foreign Application Priority Data
Apr. 13, 2004 (GB) 0408208.7

(51) Int. Cl. H04N 7/18

(52) U.S. Cl. 348/155; 348/143

(57) ABSTRACT

A security monitoring system uses video inputs to distinguish objects in motion from stationary objects. When an object in motion becomes stationary the system may set an alarm. For example, the alarm may indicate a particular video feed and a location within that feed to locate the newly stationary object for security personnel. Various techniques may be employed in conjunction with the video analysis to reduce false alarms. Hence, the invention facilitates monitoring of multiple video inputs by relatively few security personnel.

### FIELD OF THE INVENTION

The present invention relates to a an automated method and system for monitoring of an area or areas with a view to providing alerts upon the occurrence of particular events.

### BACKGROUND TO THE INVENTION

It is well known, and increasingly the case, that many places, such as public areas in airports or railway stations, shopping centres, other buildings or rooms in or entrances to buildings, roads or aircraft, are subject to monitoring, for instance by cctv cameras. The purposes of such monitoring vary widely and include the detection of theft or burglary, the monitoring of crowd behaviour as well as the detection of possible security alerts.

Typically in such contexts the video feeds from the cameras are supplied to one or more video monitors which can be watched by one or more security personnel. The intention is that those watching the video feeds will detect situations such as those referred to above and initiate appropriate action in response.

Such systems are inherently difficult to operate reliably. With the increasing amount of video data to be monitored, corresponding to the generally increasing number of cameras being used, it is difficult for all the video feeds to be effectively monitored. It becomes necessary either to increase the number of monitoring personnel or for each person to monitor more video feeds with the inherent increase in likelihood that something of significance will not be noticed.

It will be understood that such existing systems are very labour intensive and have a high associated cost. Despite the high costs there are still significant risks of human error. In this context it has been proposed to offer the monitoring service at remote locations by specialised personnel, but this does not deal with the inherent problems mentioned above while introducing a further cost associated with the transmission of the data to the remote location.

### SUMMARY OF THE INVENTION

In a first aspect, the present invention provides a monitoring method and system in which measurements are derived from input signals received from monitoring sensors and the measurements are evaluated according to certain criteria. If certain conditions are met, an alert signal may be output. Preferably of course this is done on a real-time basis so that immediate responses to situations can be provided.

In general terms, the criteria according to which the evaluation is made may be determined such that the invention operates to identify anomalous behaviour within the scene. (It should be understood that the term ‘scene’ used herein refers to the general area monitored by the sensors which may or may not include sensors sensitive to visual data, and may include other types of sensor, such as sensors sensitive to audible information.) The criteria may be preset according to an operator's knowledge of the scene, or may by dynamically altered according to the observations made within the scene, or there may be a combination of both.

Thus this detection of anomalous behaviour is two-fold, and can be considered as comprising a Measurement component and an Inference component. The measurement component is responsible for generating descriptors, representative of the scene composition and scene evolution. The inference component is given the responsibility of interpreting these descriptors, and producing an estimate of what is actually happening in the scene. That is, what is the probability that there is a dangerous situation occurring?

The power of the system is in the development of a unique set of metrics describing the scene under surveillance, and then combining these metrics using aggregate data fusion techniques to produce a single estimate of scene stability. Ultimately, the system will learn to trust certain metrics more than others as a sensor confidence matrix can be developed by comparing the anomaly detection success rate of each metric during an initial training period.

A first advantage of the invention is that it performs the basic evaluation of the input signals, instead of human operators performing this role, leaving the operators able instead to respond to particular events identified by the alert signal. This reduces the overall manpower required to operate the system while simultaneously improving reliability above that which can usually be expected. Also, it may that information is gathered from the scene using sensors which are sensitive to other parameters such as sound, smell, or non-visible electromagnetic radiation, which are difficult or impossible for a human operator to interpret directly. Thus further improvement over human operated systems can be achieved.

As mentioned above, this invention can derive advantages from combining data from a number of different kinds of sensors. Additionally, or alternatively, advantages can be obtained by subjecting the same or similar raw input data to more than one type of processing to derive information about more than one characteristic of the scene and combining the indications given by the plurality of processes. Some possibilities for the types of processing which may be done are described in relation to the second aspect of the invention below.

The second aspect of the invention relates to particular schemes for analysing input information to provide measurements of certain criteria. These may be directly useful for the indication of certain events or characteristics within the scene, or may be used individually or in combination within the first aspect of the invention described above.

As discussed above, the monitoring sensors with which the invention can be used may be cctv cameras, in which case the invention provides measurement means comprises image processing means arranged to process the input video streams in order to derive particular parameters from it. These parameters may for instance be related to an amount of movement in the scene represented by people moving around, and this may be compared with an expected value, possibly related to time of day, to assess if an alert should be indicated. In this context it may be that either an increased amount of movement, possibly representing a crowd disturbance, or a decreased amount or movement, possibly representing a security situation for instance in a bank could trigger an alert.

In a presently preferred embodiment of this aspect of the invention described in more detail below the image processing may be arranged to detect changes in the generally stationary portion of the scene, which may be indicative either of the removal of an object (theft) or of the placing or leaving of an object which requires investigation.

Another alternative is that the sensors may detect sound levels in which case the invention can be set to respond to abnormal sound levels.

The alert signal in the first or second aspect of the invention may be provided in a number of ways. For example, in the case where video signals are being monitored, the alert may be provided in the form of a highlight on the screen to alert a watching operator to the detected potential problem. This enables the operator immediately to view the incident on the screen for preliminary evaluation and also to provide immediate confirmation of the exact location if attendance at the location is required.

As with known alarm systems, the alert may be provided locally, or remotely without the knowledge of people in the monitored area.

### BRIEF DESCRIPTION OF THE DRAWINGS

The invention will be better understood from the following description of a preferred embodiment, given by way of example, in conjunction with the accompanying drawings, in which:

FIG. 1 is a block diagram of a system according to the first aspect of the present invention;

FIG. 2 is a schematic functional representation of a preferred embodiment of the second aspect of the invention; and

FIG. 3 is a sketch of an edge contour traced by the system of FIG. 2.

### DETAILED DESCRIPTION OF THE DRAWINGS

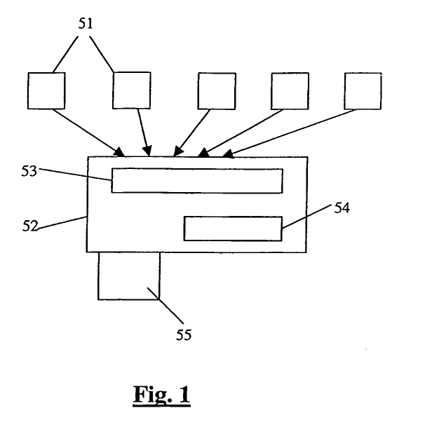

FIG. 1 is a block diagram of an overall system operating according to the first aspect of the invention outlined above. In this system, a plurality of sensors 51 are arranged to gather information about a scene. Sensors 51 may include one or a plurality of cctv camera arranged to provide a video stream representative of the visual appearance of the scene. Sensors 51 may include one or more microphones or other sound detection devices arranged to provide a signal representative of the sounds occurring in the scene. Sensors 51 may include one or more sensors sensitive to particular chemicals, possibly air-borne, within the scene, which chemicals may or may not be detectable as smells by the human nose. Sensors 51 may include pre-existing sensors which form part of other installed systems, such as smoke or fire detectors.

The outputs from sensors 51 are provided as inputs to Processing Means 52. Processing means 52 comprises an evaluation means 53 and an inference means 54, and is arranged to provide outputs via output means 55. Output means 55 may include one or more visual display devices, and/or one or more audible output devices.

Evaluation means 53 receives the signals provided by the sensors 51 and subjects the signals to processing whereby to derive information about the scene therefrom. Particular types of processing are described below in conjunction with the second aspect of the invention. However it may be noted here that the evaluation means processed each input signal according to the type of sensor it is derived from, and any one input signal my be subject to multiple types of processing to derive different type of information. The evaluation means 53 outputs the results of this processing.

The results may be suitable for useful application direct to output means 55, or they may be applied to Inference means 54. Inference means 54 is configured to assess whether, based on the results of the evaluation, an alarm condition should be raised on the basis of what has been detected about the scene. In particular, Inference means 54 can combine the results from different types of sensor to determine if an alarm condition should be raised.

FIG. 2 illustrates as an embodiment of the second aspect of the invention one type of processing which may be conducted by the evaluation means shown in FIG. 1. This is illustrated by discussion of a system adapted to monitor video images, such as those provided by cctv cameras, and to respond to changes in the stationary elements of such images. The system may therefore be used for the monitoring of a public space, for instance an airport terminal or railway station, to detect the leaving of articles, while ignoring the general movement of people in the scene.

In general terms, in this embodiment, an input image stream is processed in the first stages frame by frame. Initially each frame is subject to edge detection processing (such as high-pass filtering) in a known fashion to determine the position of edges in the frame. Following this, groups of consecutive frames are compared to determine which of the detected edges persist from frame to frame. Any edges that do not persist are discarded. This removes data related to moving objects in the scene, such as people.

For the remaining pixels which are detected as persisting edges, one or more maps or tables are constructed recording data for each such pixel. Such data may include a record, for each pixel, of the first time the pixel was noted as an edge pixel, and the last time it was so noted. These map or maps are updated and also monitored according to particular parameters and thresholds to determine firstly which edges form part of the truly stationary background to the scene, and also which edge pixels have persisted for sufficient time to indicate a potential left item.

If pixels are established which fulfil this criterion then further processing is done to trace the contour of the edge in the image. In broad terms if the traced contour meets predetermined criteria an alert is triggered.

FIG. 2 is a function map of a particular embodiment of this scheme. Processing is conducted on the video output 10 of a cctv system 1. In the following description, for simplicity the processing of a single video stream is described, it being understood that typically the video output from many cctv cameras would be simultaneously monitored.

Video stream 10 is supplied to a display means 2, such as a CRT display, for live monitoring of the scene by personnel if desired, and also for the presentation of the alert signal as described below. The video stream 10 is also input to a video storage device 3, which may take any form, such as a VCR, or solid state memory, as is known in such systems to provide a record of what has been monitored.

Further, for the implementation of this invention, the video signal 10 is also input to detection means 4. In the present implementation, video signal 10 is firstly converted to a black-and-white signal (41). This advantageously reduces the amount of data in the video stream, but is not essential to the working of the subsequent processing. Video signal 410 is thus a black-and-white version of video signal 10 and typically has a frame rate of 25 Hz.

This signal is input to edge detector 42 which outputs a signal 420. This signal 420 indicates, on a frame-by-frame basis, whether each pixel in each frame is part of an edge. This processing may be done in any suitable fashion, typically by high-pass filtering of each image in signal 410.

Signal 420 thus essentially represents a binary map of the image pixels indicating which pixels are edge pixels produced at a frequency of 25 Hz. This is input to edge overlay processing 43. Edge overlay processing 43 overlays groups of five consecutive images or maps of signal 420 and determines a pixel to be a persisting edge pixel if it appears as an edge pixel in each of those five images. Output signal 430 is then a binary map of such persisting edge pixels produced at a frequency of 5 Hz.

Considering then the input video signal, objects and other features of the scene which remain stationary and unobstructed from the view of the camera for a fifth of a second will give rise to persisting edge pixels in signal 430. Edge pixels resulting from, the instance, moving people or trolleys, will not appear in signal 430.

Signal 430 is applied as an input to edge map 44. Edge map 44 contains a record for each pixel of the scene indicating whether that pixel is currently recorded as an edge pixel, and certain time characteristics. When a pixel first appears as an edge pixel in signal 430, that pixel is recorded as an edge pixel in map 44. Corresponding time T₁ is also set to indicate the first time that pixel appeared as an edge pixel. Subsequently, each time such an edge pixel appears again as an edge pixel in signal 430 time T₂ is set, and thus time T₂ is, at any time, an indication of when that pixel last appeared as an edge pixel in signal 430. If a pixel does not appear as an edge pixel in a particular image in signal 430 it is not immediately reset as not an edge pixel in map 44, but time T₂ is not updated.

Resetting of the edge condition for the pixels in map 44 is controlled by processor 45. Processor 45 monitors the values of T₁ and T₂ and determines whether the edge condition for each pixel should be reset. This may be done simply by “ageing” the pixels according to the length of time which has passed since T₁. Thus an object which is placed stationary in a location for a period of time and then moved will thereafter be aged out of map 44 after a certain time period.

Such an ageing scheme can be further improved by additionally taking account of the time which has passed since time T₁. In general terms, the processor 45 may operate such that the longer the length of time since time T₁, the longer the time which must pass after time T₂ before a pixel is aged out of map 44. In this case, in addition to the ageing out of objects left for a short period and then moved as noted above, features of the background scene, which will have older times T₁, will tend not to be aged out of map 44 if an object is placed in front of them to obscure them for a relatively short time period.

In operation it may be that the system initially operates in a learning phase, when the scene is kept clear of all items other than those which may be considered to form background, and during which the system records the edge pixels of the background scene. During subsequent operation, the edge pixels known to be background may be specially treated in the ageing process mentioned above, or at least this phase serves to establish old times T₁ for these pixels.

If processor 45 detects pixels which are not background but which have persisted in map 44 for a sufficiently long time this is considered to be a potential alert situation. It is possible that an alert could be signalled at this stage simply on the basis of the persistence of the edges indicating a change in the stationary parts of the scene.

In the preferred arrangement however further processing is done in the form of edge contour tracing 46. This functions to prevent individual pixels which persist in map 44, but which may be caused by a malfunction, causing alarm conditions, and also permits some additional intelligence to be applied.

In contour processing 46, contour shapes defined by sequences of adjacent edge pixels in map 44 are traced and analysed and alarm condition are raised on the basis of the analysis.

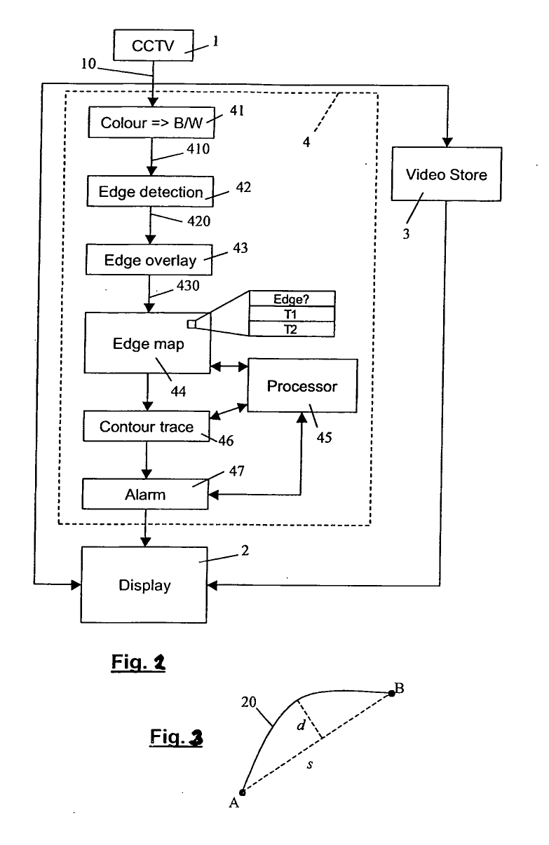

In the context of airport security as mentioned above it is of particular interest to detect items of luggage which have been left unattended. It is found that such items typically generate edge images from two physical edges which may appear as a contour 20 as shown in FIG. 3. A candidate contour may be assessed according to certain criteria before an alarm is raised.

For instance it may be that the separation s between the two points A and B at the ends of the contour must exceed a particular value, or fall within a certain range. It may be that the ratio of the maximum displacement d to separation s must exceed a particular value. It may be that the product of d and s must exceed a particular value. It may be a combination of two or more of these or other criteria.

The particular criteria to be met may be set according to the type of incident to be monitored, the location, the time of day or any other consideration. In any event, when an alarm condition is determined a suitable signal is provided.

In the preferred embodiment this is done on display 2. The location within the image of the contour which caused the alarm condition is known and so a highlight signal, such as a red box, may be superimposed on the video signal 10 shown at display 2 so that an operator can immediately see which object of other feature in the image has caused the alarm condition.

Many further developments are possible to this basic system. It is possible, when an alarm is revised, to display at display means 2 images from the time at which the object of concern was left according to time T1 in map 44, by accessing the video store 3, which may provide useful information to the operator.

The system may alternatively be configured to respond to the disappearance of items it knows should be present and thus be sensitive to theft. With the appropriate handling of the times recorded in map 44, again images of the time of the theft can be accessed.

In this embodiment, features of the data handling described above are highly efficient in terms of the amount of data to be stored, such as the edge map, and thus facilitate the simultaneous processing of video data from many input devices.

Other kinds of processing are also proposed within this invention. These can provide useful outputs individually as embodiments of the second aspect of the invention and can be incorporated into the first aspect

Additional processing schemes proposed for application to video signal inputs can be grouped into two classes: those which make calculations based on the detected motion in the image, and those which make calculations based on the distribution of skin colored regions in the image. Below is a brief description of each of the video metrics:

Motion Cues

Motion Quantity: Motion quantity is a representation of the amount of motion in the image. Motion detection is performed using a combination of frame differencing and optical flow algorithms. Frame differencing compares multiple frames and identifies regions of the scene which appear different in consecutive video frames. Optical flow uses a more advanced technique and produces not only an estimate of where the motion has occurred, but an estimate of the direction of speed of motion as well. The total amount of motion detected in the image may be displayed on-screen using a bar graph.

Spatial Distribution: Spatial distribution is a representation of where the motion has occurred in the image. The information may be displayed using a histogram in both the X and Y directions. In addition to the histogram, the statistical standard deviation is derived for each of the X and Y-axes. These metrics can be used to infer whether the motion is all occurring in a particular region of the scene (usually due to a single person), or whether it is distributed across the entire scene (usually due to the movement of a large number of people).

Motion Vector Orientations: The direction of the detected scene motion is derived and may be shown on-screen using a radial bar graph. This metric is a representation of the direction of the scene motion. This can be useful in deciding whether the people in the scene are all generally moving in the same direction (due to being instructed to do so), or if they are all moving in different and random directions (possibly an indicator of group panic).

Color Cues

Flesh Tone Moment Change: Using a logarithmic transform of the pixel colors, a segmentation map can be derived of where the skin colored regions are in the image. This is usually an effective means of locating faces and arms in the video image. The flesh tone moment change metric is a numerical descriptor of how the centroid of this segmentation map changes over time. A large moment change is indicative of a large shift in the location of the people in the scene. False positives which are identified by the segmentation map (such as flesh colored areas of the plane cabin) do not create a problem since they remain static over time and thus do not affect the statistical moment of the segmentation map. This is displayed in the image by a sub-sampled (reduced size) image of the segmentation map in which flesh colored regions are shown as green, and the statistical centroid of the segmentation is shown as a red square.

Region Occupancy Evolution: Since the location of the camera within the scene is known in advance, the video image can be divided into known areas, for instance left seats, aisle, right seats, doorway, etc. of an aircraft cabin. The amount of flesh colored pixels in each of these regions is tracked and changes in this pixel count are shown on-screen for each of the cabin regions. A large change in region population indicates that either a number of people have moved into that area, or that a group of people have left that area. This is a potential indicator of scene instability.

As mentioned above, the sensors may also include microphones, in which case processing is conducted on the live audio information in order to detect insecure conditions. This processing may be conducted according to specifiable audio rules. Each rule may consist of a frequency band (e.g. 1000 hz-2000 hz) and a safe amplitude band (e.g. 200-400) along with a weight (e.g. 4). If any rule is broken, it contributes to the overall audio disturbance according to the weight associated with the rule. A short description of one possible process follows:
I. Acquire a short frame of real-time audio pulse information from the microphone (˜20 ms).
II. Apply a hamming window to (I) to smooth out discontinuities at the frame boundaries.
III. Perform a fast Fourier transform on (II) to get the frequency domain.
IV. Calculate the power spectrum on (III) to approximate the psycho-acoustical experience of volume.
V. Test to see if any audio rules have been broken.
VI. Go to (I).

The results of the processing according to these audio rules are currently may be assessed according to frequency and pulse rules.

The pulse rules are designed to send an alert when the overall sound volume becomes too great. The rules have 4 parameters: rule number, acceptable volume range, duration window size, and weight.

Audio outside the acceptable volume range will cause a rule to trigger. Experimentation has shown a volume number of 50 is a fairly loud noise. Equally as important is that the rules also have a minimum volume range, i.e. the rule triggers if the volume is too low. This is useful in determining if the microphone cord has been cut, or if someone is standing in front of it, effectively screening it from important audio signals. The duration window size is used to average the audio level for this number of frames, before determining if the rule should trigger. This is useful for the case when one loud noise is recorded such as a bang, which should trigger an alert, but also gives the ability to trigger an alert when a medium level noise is recorded for an extended period of time. The rules are also weighted.

Frequency rules are similar to pulse rules. The difference is that they have (as the name states) a frequency attached to them, so you can specify which frequency the volume has to be at before the rule triggers. One enhancement to the frequency rules are that rules may have negative relative weight values. This makes it possible to isolate certain frequencies by giving a small band of frequencies around the frequency of interest a negative weight. When this frequency, and those surrounding it gets triggered, the total contribution to the audio alert would not be as high as when the frequency gets triggered by itself.

1. Apparatus for monitoring a designated area comprising:
input means arranged to receive inputs from a plurality of video sensors arranged to survey said area;
measurement means arranged to process said video inputs to distinguish moving objects from stationary objects, and further to identify an object that becomes stationary after moving; and
alert means arranged to output an alert signal when an object becomes stationary after moving, said alert means referencing the video input that includes the object.

2. Apparatus according to claim 1 in which the alert means is operable to output the alert signal only after the object has been stationary for a predetermined period of time.

3. Apparatus according to claim 1 in which said measurement means employs contour processing to determine object size.

4. Apparatus according to claim 3 in which object size is employed to filter objects.

5. Apparatus according to claim 1 in which the measurement means is further arranged to identify an object that moves after being stationary for a predetermined period of time, and said alert means outputs an alert signal when the object moves after being stationary for the predetermined period of time.

6. Apparatus according to claim 1 in which the alert means is further arranged to highlight a portion of the video input which triggers the alert signal.

7. Apparatus according to claim 1 in which the measurement means employs edge detection processing.

8. Apparatus according to claim 1 in which the measurement means employs motion cues to determine an amount of motion in the video input, and wherein said alert means is arranged to output an alert signal when the amount of motion is greater than a predetermined amount.

9. Apparatus according to claim 1 in which the measurement means employs color cues to facilitate distinguishing different objects.

10. Apparatus according to claim 1 in which the measurement means is further arranged to process audio inputs to detect audio information, and wherein said alert means is arranged to output an alert signal in response to particular audio information characteristics.

11. Apparatus according to claim 1 in which the measurement means is further arranged to process inputs to detect particular airborne chemicals, and wherein said alert means is arranged to output an alert signal in response to detection of particular ones of the airborne chemicals.
